(19) United States
(12) Patent Application Publication
(10) Pub. No.: US 2013/0012348 A1
(43) Pub. Date: Jan. 10, 2013

(54) Epicyclic Arrangements and Related Systems and Methods

(76) Inventors: Robert Andrew Oliver, Leyland (GB); Michael Goebel, Valley City, OH (US)

(21) Appl. No.: 13/497,513

(22) PCT Filed: Sep. 8, 2010
(86) PCT No.: PCT/US10/48060

§ 371 Date: Sep. 24, 2012

Related U.S. Application Data
(60) Provisional application No. 61/241,343, filed on Sep. 10, 2009.

(51) Int. Cl. F16H 15/50

(52) U.S. Cl. 475/115; 475/31; 475/114

(57) ABSTRACT

System comprising an epicyclic arrangement. In some embodiments, the epicyclic arrangement can comprise: a first input element; a second input element fixed to an input drive shaft; a carrier that includes at least a portion that is disposed axially between the first and second input elements, the carrier being connected to an output member; and planets associated with the carrier. Some embodiments of the present systems comprise a housing in which the epicyclic arrangement is disposed; and/or fluid contained within the housing.

### BACKGROUND

The present application claims benefit of priority to U.S. Provisional Application Ser. No. 61/241,343, filed Sep. 10, 2009, the entire contents of which are hereby incorporated by reference.

1. Field of the Invention

The present invention relates generally to epicyclic arrangements, certain components of epicyclic arrangements, and systems and methods that include such arrangements, including but not limited to infinitely variable transmissions that include a an axially-oriented epicyclic arrangement, and vehicles (such as lawn tractors) that include such transmissions.

2. Description of Related Art

Examples of transmission systems that include epicyclic arrangements include those disclosed in: U.S. Pat. Nos. 3,494,224 and 5,074,830, and UK Patent Application GB 2452710 A.

### BRIEF DESCRIPTION OF THE FIGURES

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the set of embodiments depicted in the figures.

FIGS. 1A and 1B are perspective views of an embodiment of one of the present epicyclic arrangements.

FIG. 2A is an end view of the embodiment shown in FIG. 1A.

FIG. 2B is a cross-sectional view taken along line 2B-2B in FIG. 2A.

FIG. 2C is an enlarged view of a portion of the view shown in FIG. 2B.

FIG. 3A is an assembled perspective view showing the carrier and liners of the embodiment shown in FIG. 1A.

FIG. 3B is an exploded perspective view showing the carrier and liners of the embodiment shown in FIG. 1A.

FIGS. 4A and 4B are perspective, exploded views of the embodiment shown in FIG. 1A.

FIG. 5 is a cross-sectional view showing the embodiment shown in FIG. 1A as part of a system.

FIG. 6 is a perspective, exploded view of the system shown in cross-section in FIG. 5.

FIGS. 7-1 and 7-2 depict computed data relating to operational characteristics of a system consistent with the embodiment shown in FIG. 6.

FIG. 8 is a cross-sectional view of another embodiment of the present epicyclic arrangements.

FIG. 9A is an assembled perspective view showing another embodiment of a carrier and liners that may be used with the embodiment shown in FIG. 1A.

FIG. 9B is an exploded perspective view showing another embodiment of a carrier and liners that may be used with the embodiment shown in FIG. 1A.

FIGS. 10-12 are engineering drawings of a working embodiment of the system shown in FIG. 6.

### DESCRIPTION OF ILLUSTRATIVE EMBODIMENTS

The term “coupled” is defined as connected, although not necessarily directly, and not necessarily mechanically. The terms “a” and “an” are defined as one or more unless this disclosure explicitly requires otherwise. The terms “substantially,” “approximately,” and “about” are defined as largely but not necessarily wholly what is specified (and include wholly what is specified) as understood by a person of ordinary skill in the art. The terms “comprise” (and any form of comprise, such as “comprises” and “comprising”), “have” (and any form of have, such as “has” and “having”), “contain” (and any form of contain, such as “contains” and “containing”), and “include” (and any form of include, such as “includes” and “including”) are open-ended linking verbs. As a result, a system or method that “comprises,” “has,” “contains,” or “includes” one or more elements possesses those one or more elements, but is not limited to possessing only those one or more elements or steps. Likewise, an element of a system or method that “comprises,” “has,” “contains,” or “includes” one or more features possesses those one or more features, but is not limited to possessing only those one or more features. Furthermore, a structure (e.g., a device) that is configured in a certain way must be configured in at least that way, but also may be configured in a way or ways that are not specified. Metric units may be derived from the English units provided by applying a conversion and rounding to the nearest millimeter.

The present epicyclic arrangements can take different forms (the planets (or planet elements) may be, for example, balls or rollers) and be used in different applications, including but not limited to as part of an infinitely-variable transmission (IVT) that includes a continuously-variable transmission (CVT) that provides one of the inputs to the arrangement, and in any application to which a traditional epicyclic gearset or geartrain could otherwise be used (examples of which will be discussed below). As those of ordinary skill in the art will understand, embodiments of the present epicyclic arrangements can be used in combination with a CVT to provide an IVT having a geared neutral condition. In “geared neutral” (e.g., at a geared neutral ratio), the two inputs to the epicyclic arrangement cancel each other out, leaving the output of the arrangement stationary. In such a state, the engine (or other prime mover) can remain running and coupled to the drive wheel(s) through the transmission while the vehicle is stationary, thus eliminating the need for a clutch to de-couple the engine from the drive wheel(s).

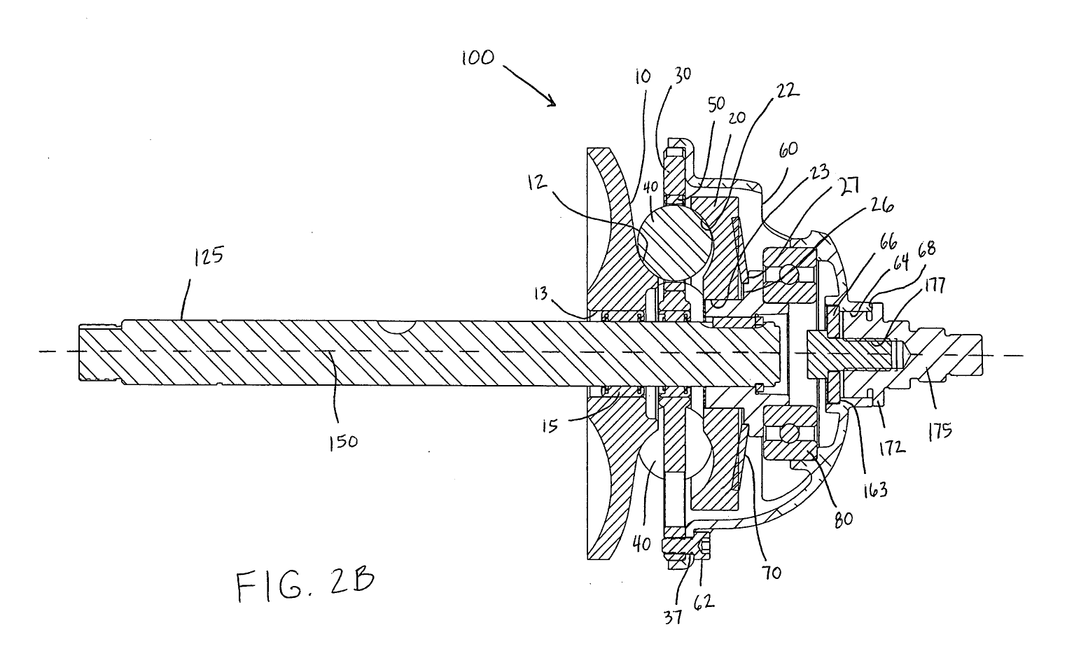

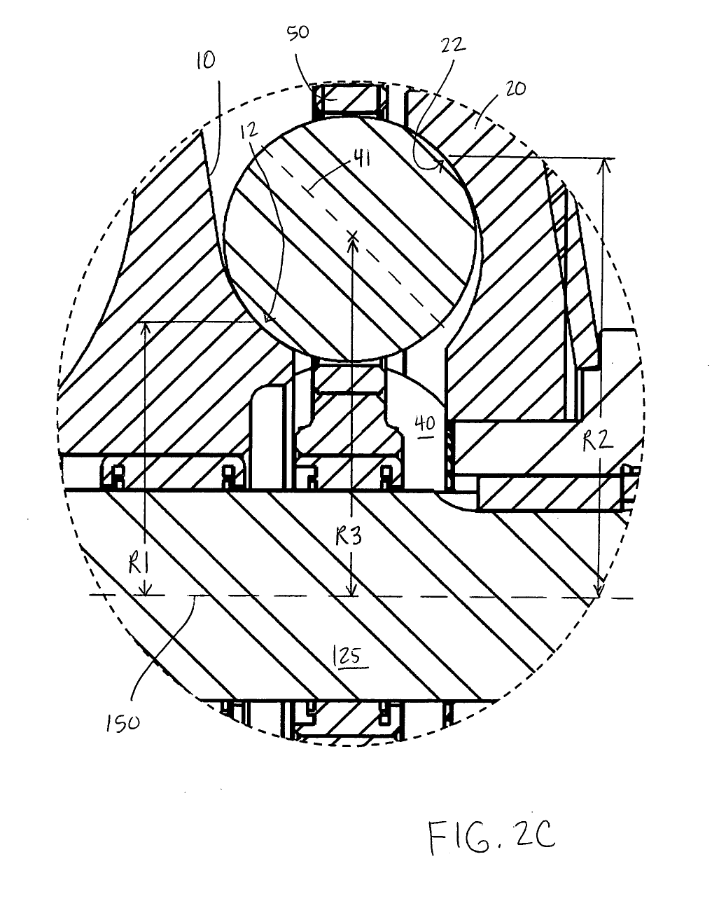

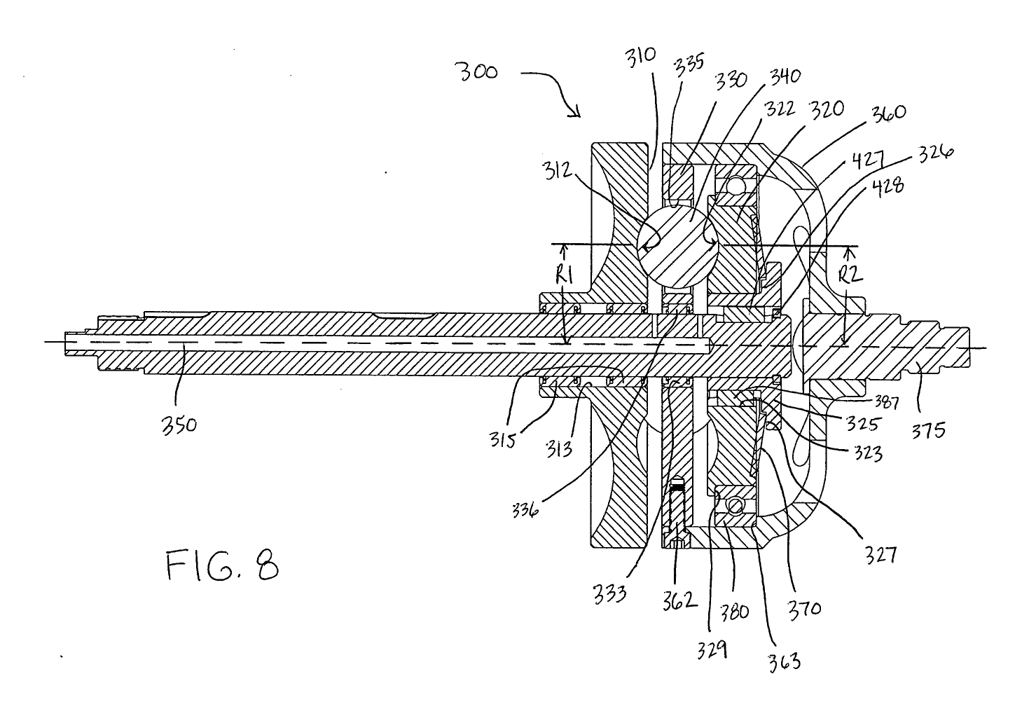

In some embodiments, the present epicyclic arrangements transmit drive between components through traction rather than friction at some time (however brief) during their normal operation, meaning that the components involved in the drive transfer do not (preferably) come into actual contact with each other. Instead, a thin layer of traction fluid (which may also be characterized as traction drive fluid) separates the components and possesses properties sufficient to enable the drive transfer. For example, long chain molecules used in the traction fluid interlock with each other when the fluid is compressed, becoming highly viscous (glassy) under pressure. An example of a suitable traction fluids that may be used with the present arrangements and systems is INVARITORC 105 traction fluid (available from Valvoline (Lexington, Ky.), a division of Ashland Inc. (Covington, Ky.)), but traction fluids from Shell or Idemitsu may also be used, as may fluids that possess similar properties but are not marketed or sold as “traction” fluids. As pressure is exerted at the contact points between the components of the arrangement, the oil resists the tendency to slide and transmits the drive effectively. In these traction embodiments, drive is transmitted between components by traction (by shearing the thin, elasto-hydrodynamic fluid film) at some point in time (however brief) during normal operation, and not through metal-to-metal friction. The arrangements of such embodiments may be described more specifically as traction epicyclic arrangements. Even more particularly, the arrangements of such embodiments may be described as traction axially-oriented epicyclic arrangements. In some embodiments, an epicyclic arrangement that is axially-oriented is one in which the annulus and sun gears are spaced apart from each other along the direction of the axis about which the arrangement rotates, such that no portion of the annulus overlaps in the axial direction any portion of the sun (an example of such an arrangement is shown in FIGS. 2B and 8). In some embodiments, an epicyclic arrangement is axially-oriented if the load or loads that are transferred across the elements of the arrangement have an axial component (in contrast to a radially-oriented epicyclic drivetrain, where the load or loads transferred across the elements do not possess an axial component under ideal operating conditions).

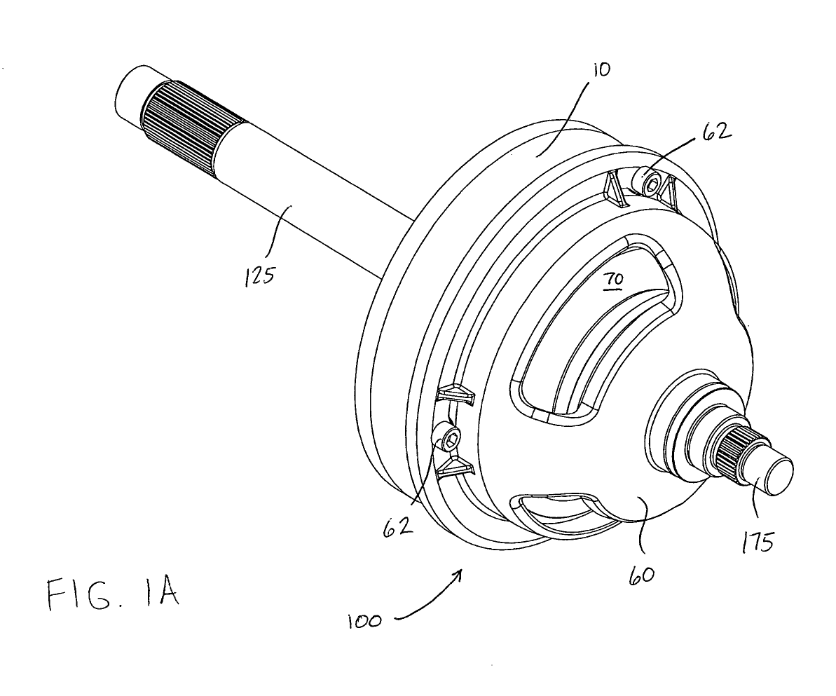

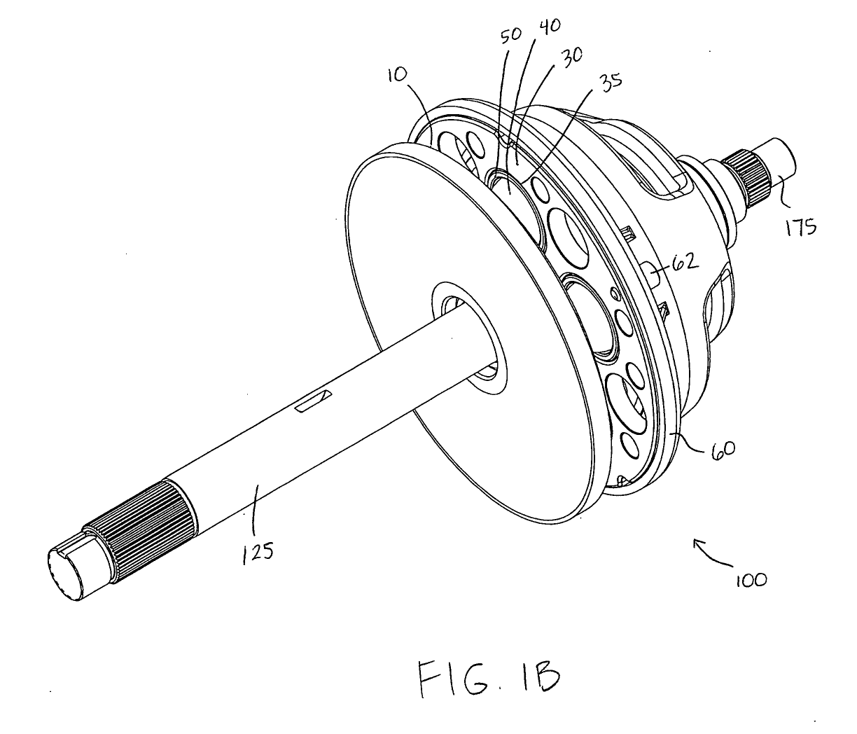

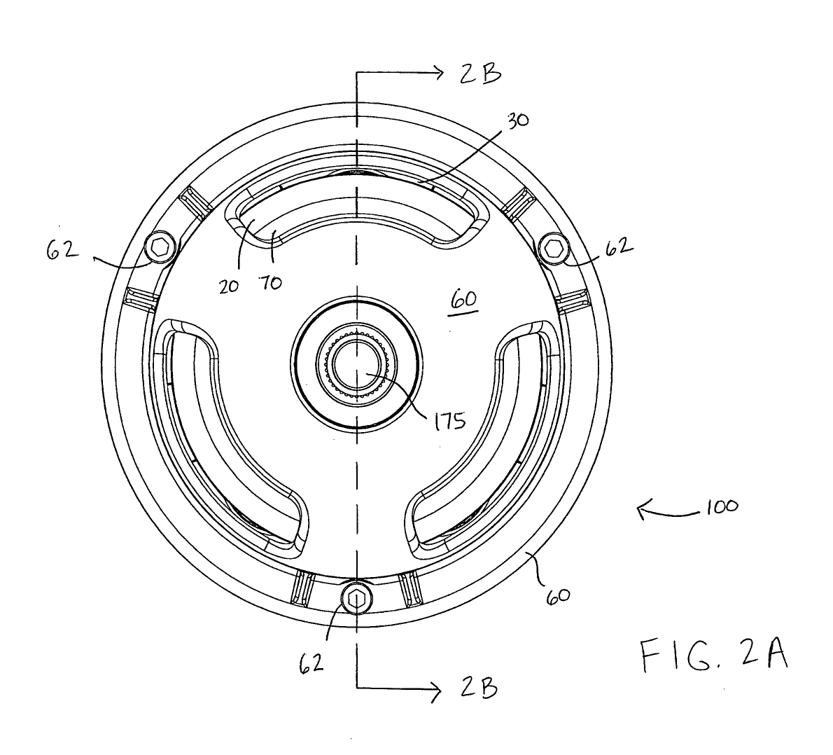

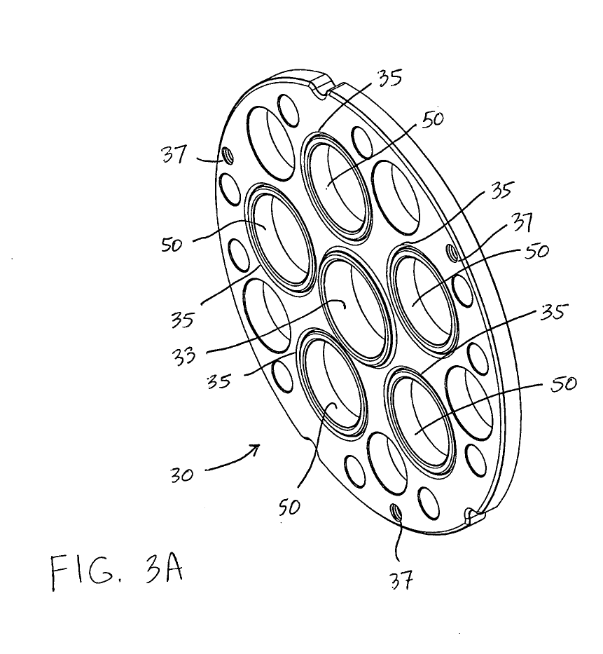

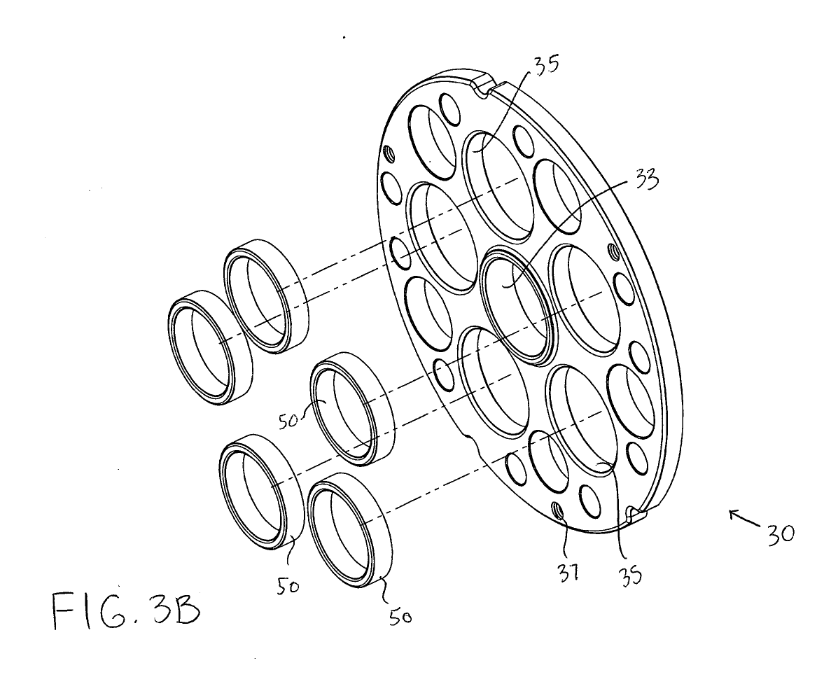

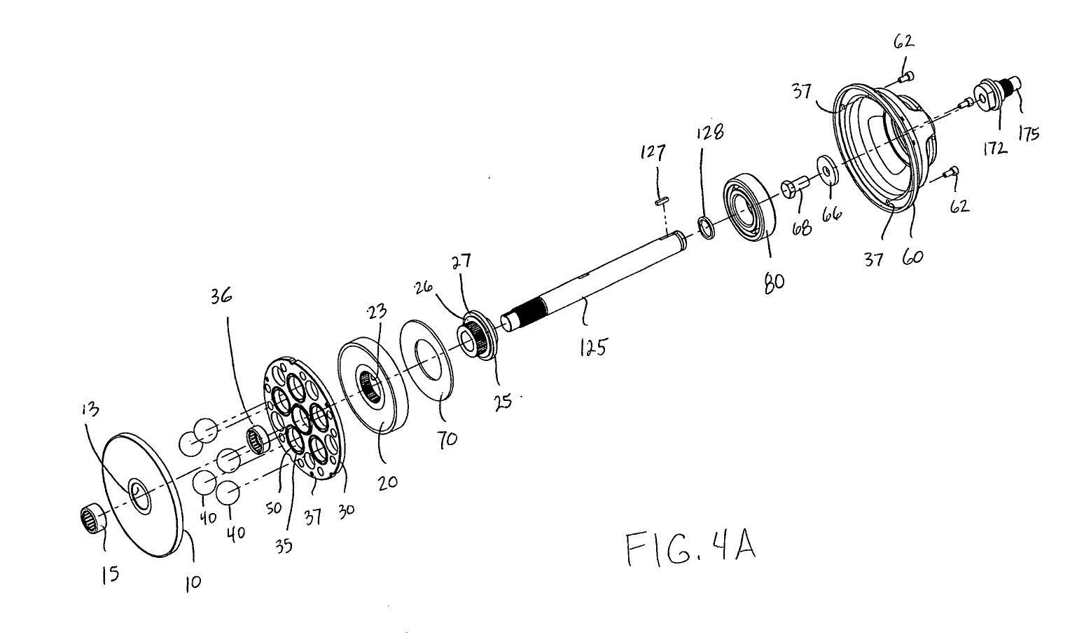

One embodiment of the present epicyclic arrangements that can be used as part of a larger system (such as an IVT) is shown in FIGS. 1A-4B. Epicyclic arrangement 100 (which may also be characterized as an axially-oriented epicyclic arrangement, or a traction axially-oriented epicyclic arrangement) includes a sun 10, an annulus 20, and a carrier 30 that includes at least a portion that is disposed axially between the sun and the annulus (meaning that at least a portion of the carrier does not overlap in the axial direction with any portion of either the sun or the annulus, as FIG. 2B shows); in the depicted embodiment, this portion comprises substantially all of carrier 30. Arrangement 100 rotates about axis 150, which is centered in input drive shaft 125 and output drive shaft 175. Consequently, sun 10 (which is a disc or plate in the depicted embodiment), annulus 20 (which is a disc or plate in the depicted embodiment), and carrier 30 (which is a disc or plate in the depicted embodiment, and may be referred to as a carrier plate) also each rotate about axis 150. Arrangement 100 also includes planets 40 associated with carrier 30.

In this embodiment, carrier 30 has openings 35 that are aligned circumferentially about the center of carrier 30 (or about axis 150) and are angularly spaced apart from each other. In this embodiment, the angular intervals are substantially equal to each other, but need not be in other embodiments. In this embodiment, arrangement 100 also includes liners 50 that are coupled to carrier 30. More specifically, a liner 50 is fixedly disposed in each opening 35 (meaning the liner does not rotate within the opening). In this embodiment, planets 40 comprise balls (which may also be referred to as spherical planets, spheres, drive balls, or drive spheres) that are positioned in openings 35 of carrier 30, and more specifically are positioned in liners 50. In this regard, each planet 40 may be characterized as being completely surrounded by and rotatable in a liner 50 (which, in this embodiment, is an annular liner). More broadly, however, liners 50 are one example of a liner (or a carrier opening liner) that is positioned in opening 35 and that separates a planet from the carrier (and, more specifically, from the carrier material that defines the carrier opening in question). Liners 50 are also examples of liners that are configured to prevent any contact, at least during operation of the arrangement, between the planets and the carrier material that defines the openings in which the planets are positioned.

In this embodiment, there are five openings, five annular liners, and five spherical planets; in other embodiments, there may be any number of each greater than one (e.g., two, three, four, six, seven, or more).

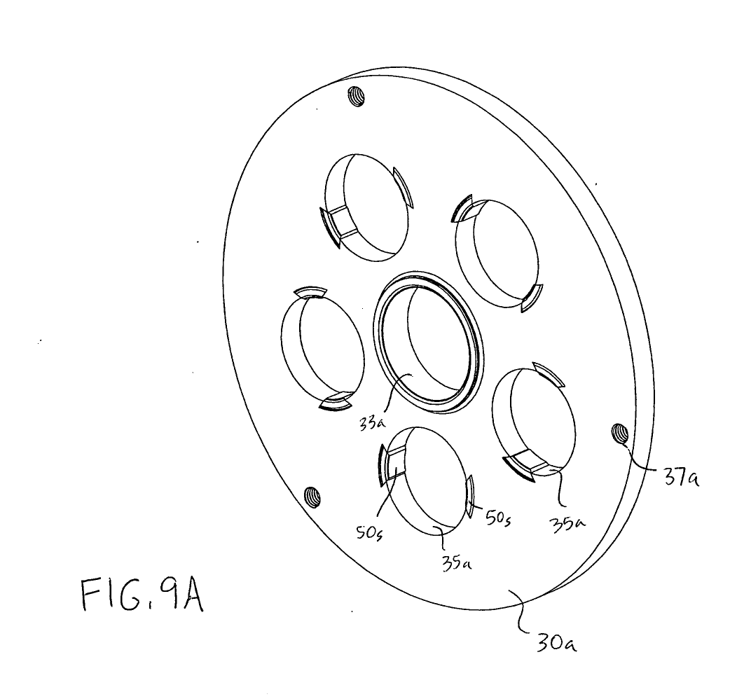

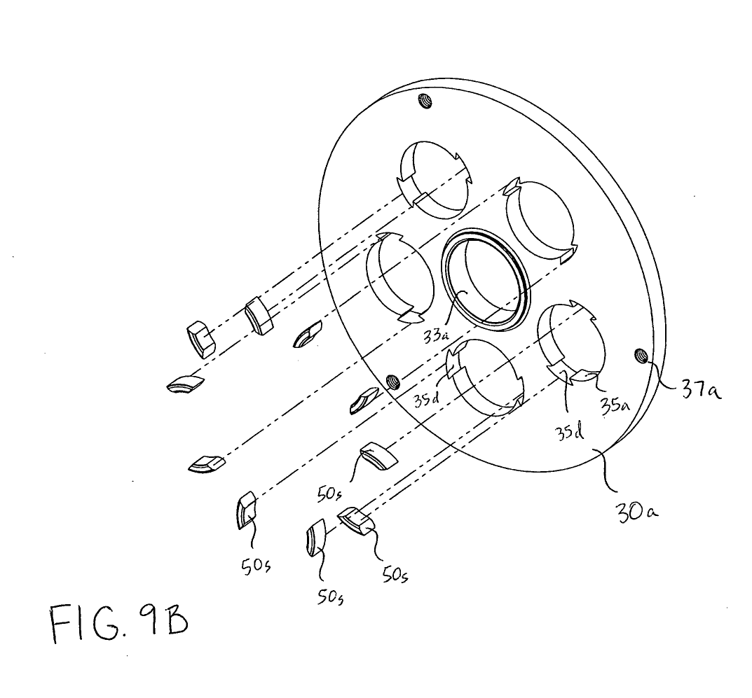

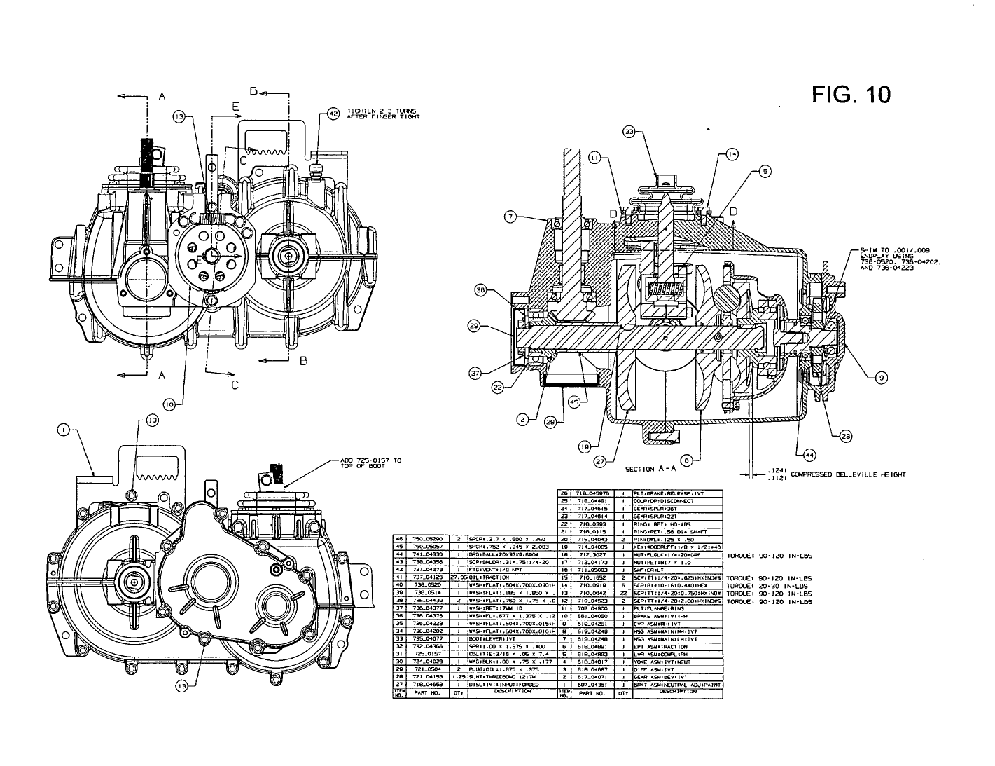

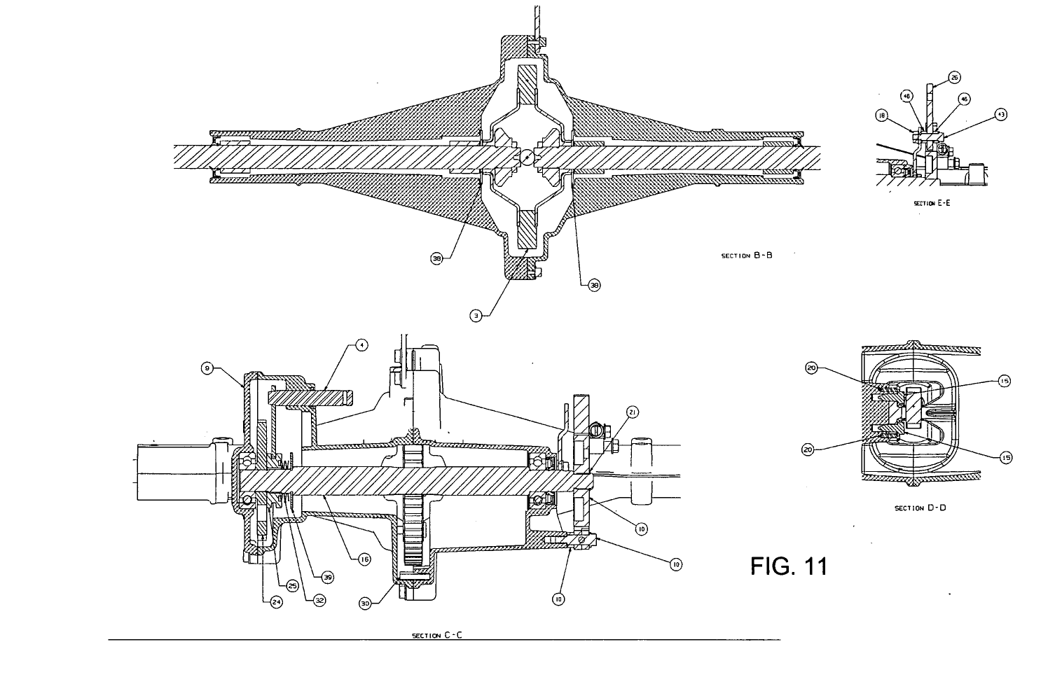

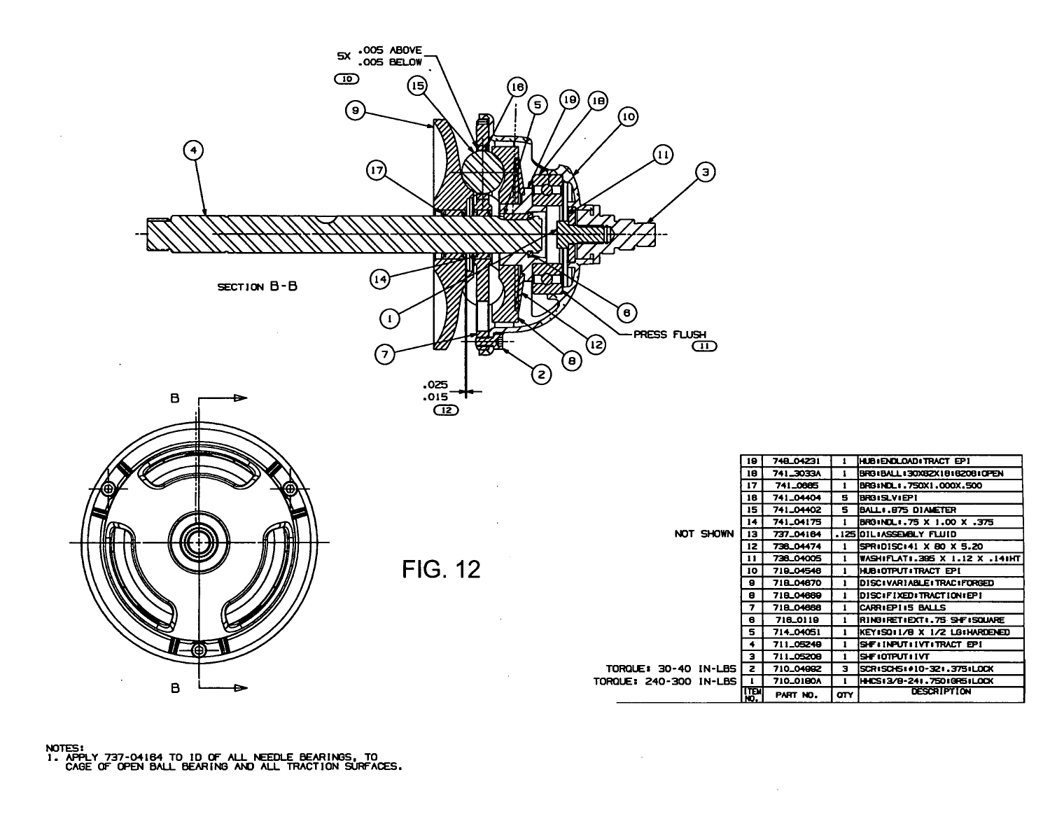

In addition, while liners 50 are continuous annular rings, other embodiments of the present liners may be used that are not continuous annular rings (see FIGS. 9A and 9B) but that still serve to eliminate contact, at least during operation of the arrangement, between spherical planets and the carrier material that defines the openings in which those planets are positioned.

Planets 40, because they are balls, need not be supported on any form of shaft or bearings, whereas a traditional geared planet or a planet configured for radial traction does. Furthermore, planets 40—because they are spherical—are examples of planets that transmit load through their respective centers with no moment tending to displace a given planet.

In the depicted embodiment, carrier 30 is connected (specifically, it is fixedly connected) to an output member 60; as a result, the rate of rotation of output member 60 (which, in the depicted embodiment, is a hub that is bolted to the carrier using axially-oriented screws 62 placed through threaded openings 67 of the hub and through corresponding threaded openings 37 in carrier 30) is the same as the rotate of rotation of carrier 30.

During normal operation of arrangement 100, the planets are constrained circumferentially by the carrier (more specifically by the openings in the carrier, and even more specifically by the annular liners in the openings) and in the axial direction by the sun and the annulus.

In the depicted embodiment, arrangement 100 also includes force generator 70, which is in contact with annulus 20 and is configured to apply an axial force (which also may be characterized as a clamp force or an end load) to annulus 20. A force or direction that is described as “axial” is one that is parallel to (though not necessarily aligned with) the axis of rotation of the epicyclic arrangement. In this embodiment, force generator 70 comprises a disc spring, such as a conical belleville washer, which is shown in interference with the backside of annulus, as those of ordinary skill in the art familiar with engineering drawings will understand. In other embodiments, the force generator could comprise any suitable device (such as a variable hydraulic clamp device or a different mechanical clamp device) and be located in any suitable position for delivering an appropriate end load or clamp force to annulus 20.

In the depicted embodiment, sun 10 includes a sun track 12 along which drive will be transferred between the sun and the planets during normal operation of the arrangement, and annulus 20 includes an annulus track 22 along which drive will be transferred between the annulus and the planets during normal operation of the arrangement. Sun 10 and annulus 20 are examples of what may be referred to as input elements. In some embodiments, the distance R1 between the center of sun track 12 and axis 150 is less than the distance R2 between the center of annulus track 22 and axis 150. In other embodiments, the two distances are substantially the same (and may be the same); in such embodiments, the sun and annulus are be referred to an input elements. The centers of these tracks may be located such that a line extending through them intersects axis 150 at 45 degrees, though other values for R1 and R2 may be used (and therefore different angles may be achieved). In addition to rotating about axis 150, each planet 40 also rotates about its own axis 41 (see FIG. 2C), which is perpendicular to the line intersecting the centers of the two tracks. Distance R3 shown in FIG. 2C is the distance from axis 125 to the center of planets 40 (and is, therefore, the radius of rotation of the center of the planets about axis 125).

As those of ordinary skill in the art will understand, the rate of rotation of carrier 30 (which may be characterized as the driven element (or driven element 30) of the epicyclic arrangement) is determined by the input rates of rotation of annulus 20 and sun 10 (which may be referred to as input elements 20 and 10), which are transferred to planets 40. In particular, the rotational speeds, ω, in revolutions per minute (RPM) of the elements are defined by the following equation:

ωᵢₙₚᵤₜₑₗₑₘₑₙₜ₁₀R1=2ω_{drivenelement30}R3−ωᵢₙₚᵤₜₑₗₑₘₑₙₜ₂₀R2.

In the depicted embodiment, arrangement 100 is configured to have a conformity ratio of greater than or equal to 0.80 and less than or equal to 0.90, more particularly greater than or equal to 0.81 and less than or equal to 0.89, more particularly greater than or equal to 0.82 and less than or equal to 0.88, more particularly greater than or equal to 0.83 and less than or equal to 0.87, more particularly greater than or equal to 0.84 and less than or equal to 0.86, and more particularly 0.85. In this disclosure, the referenced conformity ratio is the ratio of the diameter of a given spherical planet 40 (and, preferably, each spherical planet has the same diameter), to the ratio of one or both of the diameters of the sun track and the annulus track. Surprisingly and unexpectedly, the inventors discovered that, when the depicted embodiment is used under zero load conditions at 3000 revolutions per minute engine speed, a conformity ratio of 0.95 did not provide a stable operating condition. Under the same conditions, a conformity ratio of 0.80 did not last more than 240 hours of continuous use, and as the conformity ratio was reduced further, the durability decreased even further.

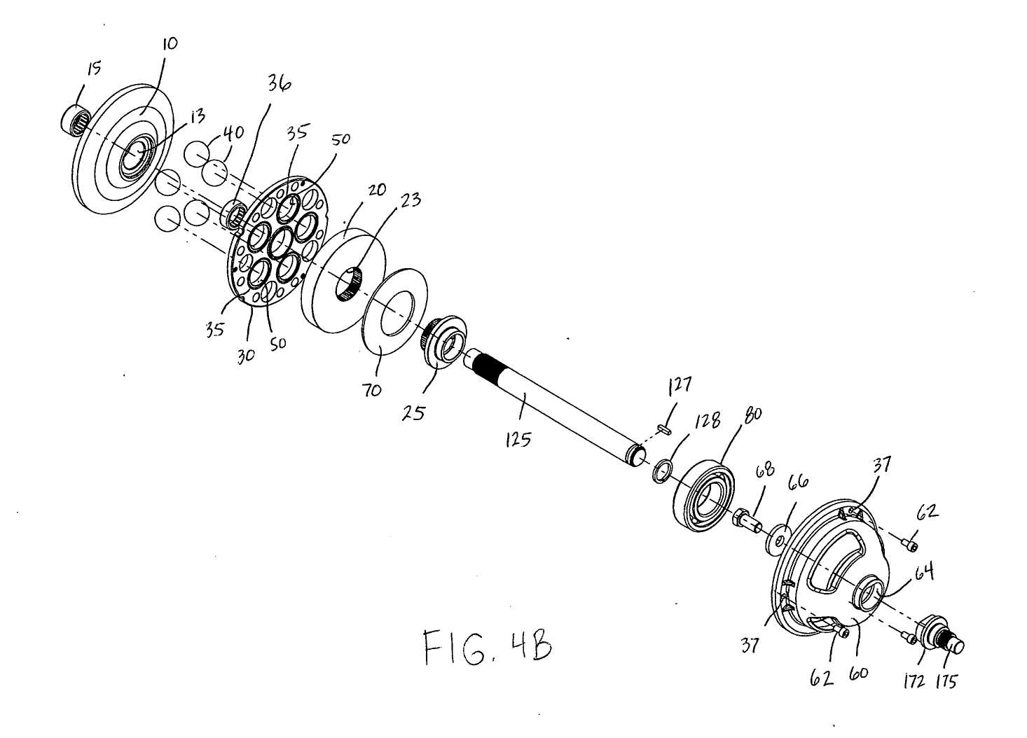

Additional details that may be part of arrangement 100 in some embodiments, or with which arrangement 100 may be used in other embodiments, are shown in several of the figures (e.g., FIGS. 1A-2B and 4A-4B). FIG. 2B, for example, shows that sun 10 has a central opening 13 that is positioned generally around input drive shaft 125. More particularly, needle bearing 15 is disposed in central opening 13 and positioned around input drive shaft 125, thus allowing sun 10 to rotate freely about input drive shaft 125. Similarly, carrier 30 has a central opening 33 that is positioned generally around input drive shaft 125. More particularly, needle bearing 36 is disposed in central opening 33 and positioned around input drive shaft 125, thus allowing carrier 30 to rotate freely about input drive shaft 125. Annulus 20 is connected to (e.g., fixedly attached to) input drive shaft 125. In particular, annulus 20 has a central opening 23 in which a hub 25 is fixedly disposed to prevent relative rotation between the two (in the depicted embodiment, an as shown in the exploded views of FIGS. 4A and 4B, the two are provided with gear teeth to enable annulus 20 to be splined to hub 25, though any other suitable connection means that will prevent relative rotation of the two may be used); hub 25 is connected to input drive shaft 125 by virtue of key 127 and ring 128, but any other suitable connection means may be used. As a result of its fixed connection to input drive shaft 125, annulus 20 rotates at the same rate as input drive shaft 125. Hub 25 includes a retention shoulder 26 configured to restrict the axial movement by annulus 20 away from carrier 30, and a clamping shoulder 27 that is configured to contact one portion of the belleville spring that comprises the depicted version of force generator 70. Ball bearing 80 is disposed between output member 60 and hub 25, and permits the smooth relative rotation of output member 60 about input drive shaft 125 and axis 150. Output member 60 is also connected to output drive shaft 175. In the depicted embodiment, this is accomplished through a splined connection between output drive shaft 175 and central opening 64 of output member 60. In addition, output member 60 includes an internal shoulder 63 adjacent to and bordering central opening 62 against which a washer 66 is positioned; output drive shaft 175 includes an outwardly-projecting shoulder 172; and a hex head cap screw 68 is threaded through the washer and into screw recess 177 in output drive shaft 175, drawing output drive shaft 175 axially toward output member 60, and causing shoulder 172 to butt against outer edge 68 of output member 60 and washer 66 to butt against internal shoulder 63 of output member 60. As those of ordinary skill in the art will recognize, other suitable techniques may be used to secure output member 60 to output drive shaft 175.

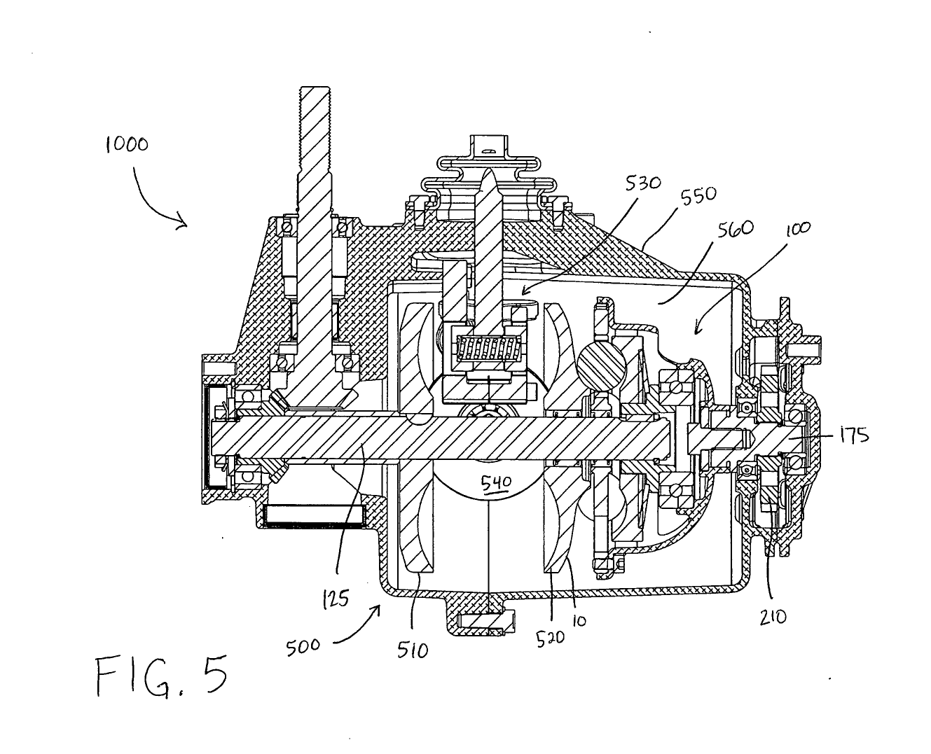

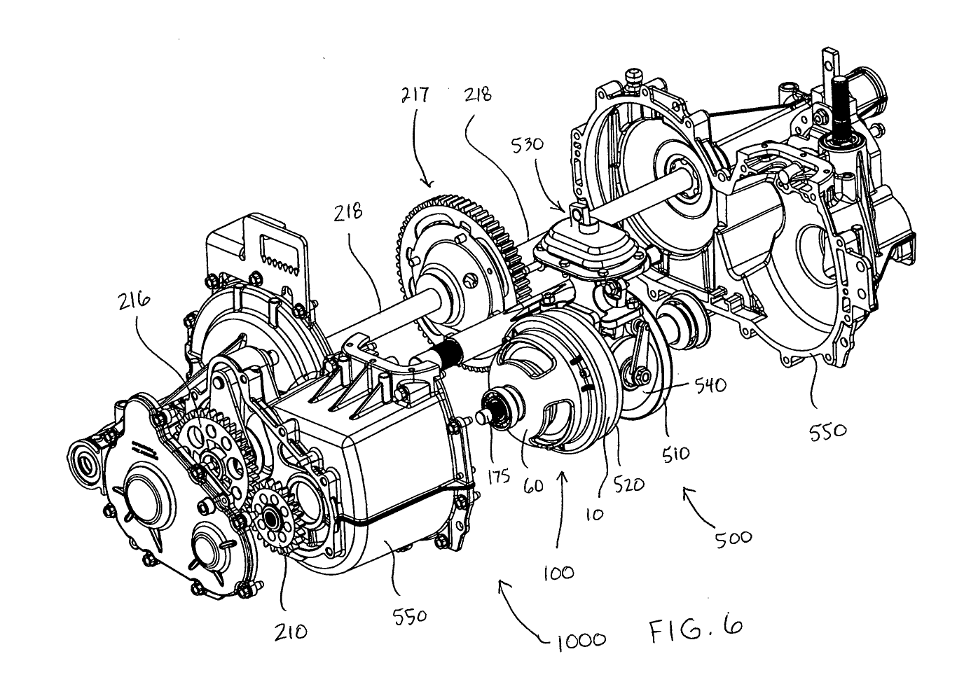

FIG. 5 shows a system of which epicyclic arrangement 100 is a part. Specifically, FIG. 5 depicts a cross-section of a portion of IVT 1000 (which is an example of a system), which comprises a conventional variator 500 that is coupled to epicyclic arrangement 100. The details of variator 500—which in the depicted embodiment is a full-toroidal race, rolling-traction type variator—will be well-understood to those of ordinary skill in the art, and need not be repeated here, though it is pointed out that variator 500 includes an input disc 510 that is connected to input drive shaft 125 using a key; output disc 520, with which sun 10 is integrally formed (in particular, sun 10 comprises the backside of output disc 520), and which rotates freely about input drive shaft 125; lever assembly 530, the movement of which controls the position of rollers 540; and housing 550, which encloses epicyclic arrangement 100 and provides a fluid-tight cavity 560 in which traction fluid (not shown) is disposed. FIG. 5 also shows that output drive shaft 175 of epicyclic arrangement 100 can be connected to spur gear 210. FIG. 6 shows an exploded view of IVT 1000, the details of which will be well-understood by those of ordinary skill in the art, and need not be repeated here, though it is pointed out that this figure illustrates one way in which the output of epicyclic arrangement 100 is connected to the drive wheels of a vehicle: spur gear 210 is connected to spur gear 216, which is connected to differential assembly 217, which is connected to drive shafts 218, which are connectable to the drive wheels (not shown). While sun 10 is integral with output disc 520 in the depicted embodiment, and the rate of rotation of the two is therefore the same, sun 10 could be non-integral with but coupled to output disc 520 in other embodiments (and its rate of rotation could still be the same as the rate of rotation of output disc 520).

In place of variator 500, any of the following continuously variable transmissions (CVTs) may be used to provide one of the inputs (through a connection to or integral relationship with sun 10), taking into consideration any axial load that may be associated with it: a belt CVT, a half-toroidal CVT, an electric-motor based CVT, a hydrostatic CVT, a hydromechanical CVT, a roller ball-based CVT (e.g., a “Milner CVT”), and a continuously variable planetary transmission (e.g., such as by Fallbrook Technologies Inc. and currently promoted under the NuVinci® brand).

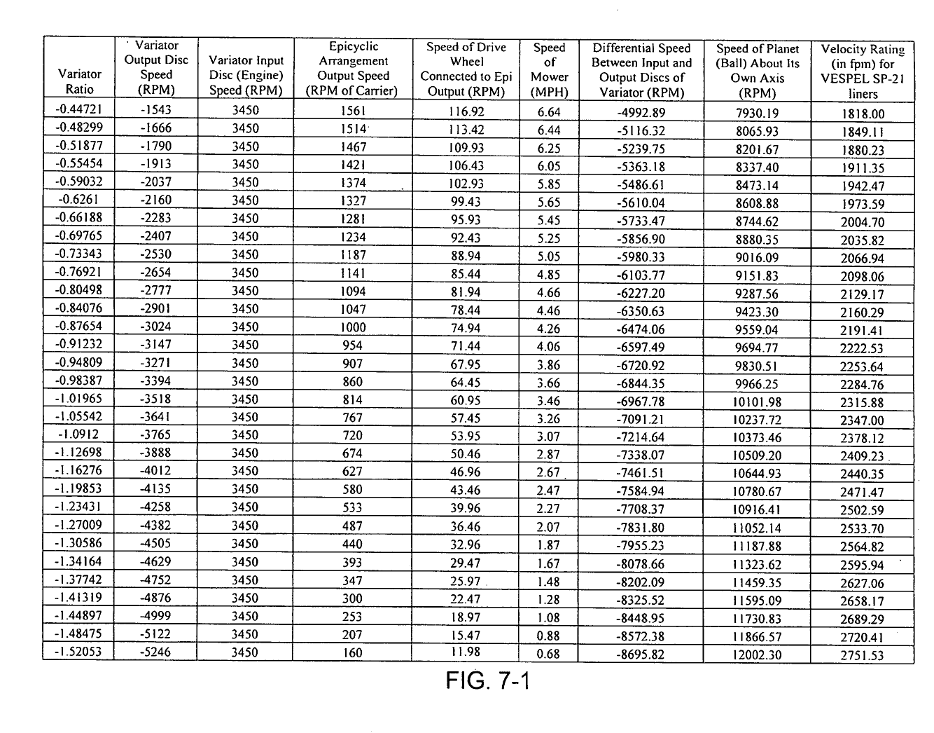

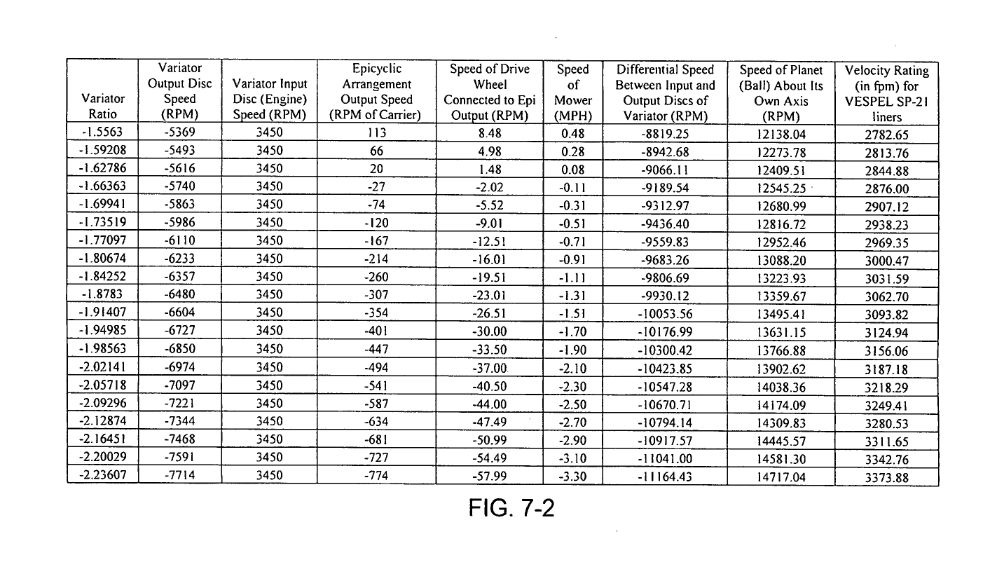

FIGS. 7-1 and 7-2 show a table containing values computed for use of the embodiment of epicyclic arrangement 100 in the system shown in FIG. 5. The computed values are based on the following assumptions: a coefficient of friction of 0.045 between planets 40 and sun 10 for one input and planets 40 and annulus 20 for the other input, which coefficient of friction results from the use of traction fluid; R1=24.44082148 millimeters (mm)/0.962237 inches (in) and R2=40.15626969 mm/1.580955 in. (see FIG. 2C); a diameter of 22.225 mm/0.875 in. for each of planets (balls) 40; a distance of 32.29854559 mm/1.271596 in. between the center of each planet 40 and (rotational) axis 150; the number of planets=5; the endload force delivered to the annulus by the force generator (the belleville spring, in this embodiment)=5000 Newtons (N); the ratio between the output drive shaft (175) and the axle of the drive wheel=13.35; the engine speed=3450 RPM; the variator ratio spread=5; the minimum variator ratio=−0.447213595; the maximum variator ratio=−2.236067977; assuming an output torque at the drive wheels of 250 foot pounds (ft lbf), the output torque of the transmission required to achieve the same was determined to be 18.72659176 ft lbf.

The version of epicyclic arrangement 100 shown in FIGS. 1A-6 includes planet tracks of different diameters (or different radii). In particular, the annulus track has a greater diameter than the sun track. However, in other embodiments of the present epicyclic arrangement, such as the one shown in FIG. 8, the epicyclic arrangement may have tracks of the same radius/diameter. Epicyclic arrangement 300 (which may also be characterized as a traction epicyclic arrangement or a traction axially-oriented epicyclic arrangement) is an example of such a arrangement, and includes sun 310 (which is a disc or plate in the depicted embodiment), annulus 320 (which is a disc or plate in the depicted embodiment), carrier 330 (which is a disc or plate in the depicted embodiment), and planets 340 (which are balls in the depicted embodiment) associated with carrier 330.

In the depicted embodiment of arrangement 300, carrier 330 has openings 335 that are aligned circumferentially about the center of carrier 330 (or about axis 350) and are spaced apart from each other at substantially equal angular intervals. Although arrangement 300 is not depicted with liners (e.g., annular or non-annular liners) fixedly disposed in each opening 335, the omission is for clarity only, and the proportion of planet size to liner size to opening 335 size may be the same as the proportion of the same components shown in FIG. 2B. In this embodiment, planets 340 comprise balls (which may also be referred to as spherical planets, spheres, drive balls, or drive spheres) that are positioned in openings 335 of carrier 330. In this embodiment, there are three openings 335 and three spherical planets 340; in other embodiments, there may be fewer (two) or more (e.g., four or more) of each.

In the depicted embodiment, arrangement 300 also includes force generator 370, which is in contact with annulus 320 and is configured to apply an axial force (which also may be characterized as a clamp force or an end load) to annulus 320. In this embodiment, force generator 370 comprises a disc spring, such as a conical belleville washer, which is shown in interference with the backside of annulus, as those of ordinary skill in the art familiar with engineering drawings will understand. In other embodiments, the force generator could comprise any suitable device (such as a variable hydraulic clamp device or a different mechanical clamp device) and be located in any suitable position for delivering an appropriate end load to annulus 320.

Carrier 330 is fixedly connected with radially-oriented screws 362 to output member 360 (which is shown as a hub) that is connected to output drive shaft 375, which is axially-aligned with input drive shaft 325 via axis 350, about which arrangement 300 rotates. Sun 310 includes a sun track 312, annulus 320 includes an annulus track 322, and the radii/diameters of these tracks are the same or at least substantially the same accounting for normal engineering tolerances. Arrangement 300 may be configured to have a conformity ratio of greater than or equal to 0.80 and less than or equal to 0.90, more particularly greater than or equal to 0.81 and less than or equal to 0.89, more particularly greater than or equal to 0.82 and less than or equal to 0.88, more particularly greater than or equal to 0.83 and less than or equal to 0.87, more particularly greater than or equal to 0.84 and less than or equal to 0.86, and more particularly 0.85. In this disclosure, the referenced conformity ratio is the ratio of the diameter of a given spherical planet 340 (and, preferably, each spherical planet has the same diameter), to the ratio of one or both of the diameters of the sun track and the annulus track.

The manner in which the rate of rotation of carrier 330 is determined is the same as that described above for epicyclic arrangement 100.

FIG. 8 shows additional details that may be part of arrangement 300 in some embodiments, or with which arrangement 300 may be used in other embodiments. Specifically, FIG. 8 shows that sun 310 has a central opening 313 that is positioned generally around input drive shaft 325. More particularly, needle bearings 315 are disposed in central opening 313 and positioned around input drive shaft 325, thus allowing sun 310 to rotate freely about input drive shaft 325. Similarly, carrier 330 has a central opening 333 that is positioned generally around input drive shaft 325. More particularly, needle bearing 336 is disposed in central opening 333 and positioned around input drive shaft 325, thus allowing carrier 330 to rotate freely about input drive shaft 325. Annulus 320 is connected to (e.g., fixedly attached to) input drive shaft 325. In particular, annulus 320 has a central opening 323 in which a hub 325 is fixedly disposed to prevent relative rotation between the two (in the depicted embodiment, the two are provided with gear teeth to enable annulus 320 to be splined to hub 325, though any other suitable connection means that will prevent relative rotation of the two may be used); hub 325 is connected to input drive shaft 325 by virtue of key 427 and ring 428, but any other suitable connection means may be used. As a result of its fixed connection to input drive shaft 325, annulus 320 rotates at the same rate as input drive shaft 325. Hub 325 includes a retention shoulder 326 configured to restrict axial movement by annulus 320 away from carrier 330, and a clamping shoulder 327 that is configured to contact one portion of the belleville spring that comprises the depicted version of force generator 370. Ball bearing 380 is disposed around annulus 320 and contacts an interior portion of output member 360, thus allowing the hub to rotate smoothly (and independently) about annulus 320. Annulus 320 includes an outer radial shoulder 329 that constrains ball bearing 380 in the axial direction. Output member 360 includes an internal shoulder 363 that also constrains ball bearing 380 in the axial direction. Output member 360 is fixedly connected to output drive shaft 375 by virtue of key 387 and a ring (not visible), though other suitable connection mechanisms may be used, such as by providing teeth on central opening 362 and teeth on output drive shaft 375 so that the two can be splined together. As those of ordinary skill in the art will recognize, other suitable techniques may be used to secure output member 360 to output drive shaft 375.

As FIG. 8 shows, sun 310 may be integrated with the output disc of a variator. As those of ordinary skill in the art having the benefit of this disclosure will appreciate, such a variator may be part of an IVT (similar in respects to the system (IVT 1000) shown in FIGS. 5 and 6). Other CVTs, such as those listed above, may be used in such a system (e.g., with epicyclic arrangement 300) in place of a full-toroidal variator.

The liners disclosed above are one example of suitable liners for use in the present arrangements and systems. The use of liners is designed to increase the useful life of the epicyclic arrangements by lessening the friction between the balls and the openings in the carrier in which the balls are positioned. Relative to some carriers without liners, the liners can help to prevent damage that might otherwise occur between the carrier and the balls. In general, the material that is used for the present liners should be softer (e.g., on a Rockwell hardness scale) than the material used for the planets.

Examples of suitable material for some embodiments of the disclosed liners include polyimide-based polymers (plastics), such as some VESPEL brand polymers manufactured by DuPont. The embodiment of arrangement 100 shown in FIGS. 1A-6 was tested at 3000 rpm under 350 ft lbf at the wheels, and liners 50 made from VESPEL SP-1 passed a lifecycle test of 500 hours, as did liners 50 made from VESPEL SP-21. Other similar materials may be used for the present liners. Though the following have not been tested, they may prove suitable: polyimide compounds comprising virgin polyimide, such as those sold by the following tradenames: VTEC PI (commercially available from Richard Blaine International, Inc., Reading, Pa.), and MELDIN 7001 (manufactured by Saint-Gobain Performance Plastics, and commercially available from Professional Plastics, Inc., Fullerton, Calif.); polyimide compounds comprising 15 percent graphite by weight, such as those sold by the following tradenames: VTEC BG21, and MELDIN 7021; polyimide compounds comprising 40 percent graphite by weight, such as those sold by the following tradenames: VESPEL SP-22, VTEC BG22, and MELDIN 7022; polyimide compounds comprising 10 percent polytetrafluoroethylene (PTFE) by weight and 15 percent graphite by weight, such as those sold by the following tradenames: VESPEL SP-211, VTEC BG211, and MELDIN 7211. Others suitable materials may include polyimide compounds sold by the following tradenames: TORLON 4301 (manufactured by Solvay Advanced Polymers, L.L.C. (Alpharetta, Ga.) and commercially available from Professional Plastics, Inc., Fullerton, Calif.) and TORLON 4435. Certain polyaryletheretherketone (PEEK) polymers may also be suitable, such as VICTREX PEEK polymer. Certain polytetrafluoroethylene (PTFE) polymers (e.g., PERMAGLIDE PTFE) may also be suitable.

In addition to polymers (and, more specifically, plastics), certain low-friction metals or alloys, such as bronze, may be used. Other potentially-suitable materials include some powder metals, such as CT-1000-K40 PM bronze or any material(s) complying with a standard set forth in the PM self-lubricating bearing handbook. Another guideline that can be used to select a suitable material is one that will meet the “pv” value required of the system in question.

In addition, while liners 50 are continuous annular rings, other embodiments of the present liners that serve to eliminate contact, at least during operation of the arrangement, between spherical planets and the carrier material that defines the openings in which those planets are positioned may be used. For example, FIGS. 9A and 9B shows an example (not to scale) of a liner that is segmented or sectioned, so that it serves the function of separating the spherical planets from the carrier material, but does not surround the planets in unbroken or uninterrupted fashion. Carrier 30a, which may be used with some embodiments of arrangement 100, includes openings 35a that are configured with liner segment attachment notches 35d (which, in this embodiment, are dovetail-shaped) configured to accept liner segments 50s, two of which comprise an example of liner that is configured not to completely surround a planet. Such liner segments are held in place through a press/friction fit. As FIGS. 9A and 9B show, the distance from the center of a given opening 35a to the closet point on any given liner segment is less than the distance from the center of that opening to the closest point on the material defining the opening. The example of a segmented/sectioned liner shown in FIGS. 9A and 9B is an example of one that can be positioned in an opening of a carrier to separate a planet from the carrier (and, more specifically, from the carrier material that defines the carrier opening in question). Central opening 33a and threaded openings 37a in carrier 30a serve the same function as central opening 33 and threaded openings 37, respectively, serve in carrier 30.

In general, the present disc-shaped carriers (e.g., carriers 30 and 330) should possess a hardness that is sufficient to withstand the output torque required at the drive wheels, as those of ordinary skill in the art will understand. An example of a hardness that has been determined to function well with liners 50 made from VESPEL SP-1 and SP-21 is 65 HRC (Rockwell C scale), though different hardnesses may be used.

In some embodiments of the present epicyclic arrangements, it may be possible to dispense with liners 50 and 50s by making the disc-shaped carriers 30 and 30a from a material that is softer than the planets but that possesses sufficient hardness to withstand the torque required to generated the desired torque at the drive wheels. Such carriers may be characterized as liner-less carriers. Arrangements comprising such carriers may be characterized as those that have no material disposed between the carrier openings and the planets.

It should be understood that the present systems and methods are not intended to be limited to the particular forms disclosed. Rather, they are to cover all modifications, equivalents, and alternatives falling within the scope of the claims. For example, while the carrier openings shown in carrier 30 are spaced apart at substantially equal angular intervals, it is possible to group the openings in other arrangements. For instance, six carrier openings 35 could be used that are spaced apart in two groups of three openings, where two angular intervals of 45 degrees separate the three openings in each group, and where the outermost openings in each group are angularly separated from each other by 90 degrees. As another example, while the carriers shown above that may be used with arrangement 100 (carriers 30 and 30a) have a generally circular outer profile, other carrier shapes may be utilized. For instance, a carrier shape that does not extend radially beyond a given portion of an opening (or notch) designed to at least partially surround a particular ball may be used; such a carrier may include notches that are comprised of less than 360 degrees of a circle but greater than 180 degrees of a circle, liners may be coupled to such a carrier in each such notch, and a ball may be positioned to be at least partially surrounded (or otherwise bordered) by a given notch.

The claims are not to be interpreted as including means-plus- or step-plus-function limitations, unless such a limitation is explicitly recited in a given claim using the phrase(s) “means for” or “step for,” respectively.

1. A system comprising:
an epicyclic arrangement, comprising:
a first input element;
a second input element fixed to an input drive shaft;
a carrier that includes at least a portion that is disposed axially between the first and second input elements, the carrier being connected to an output member; and
planets associated with the carrier;
a housing in which the epicyclic arrangement is disposed; and
fluid contained within the housing;
the epicyclic arrangement being configured such that, at some point in time during its operation, drive can be transmitted from the first input element to the planets through some of the fluid.

2. The system of claim 1, where the first input element is integral with an output disc of a variator.

3. The system of claim 1, where the planets comprises balls.

4. The system of claim 1, where the planets comprises five balls.

5. The system of claim 1, where the planets comprise balls, and the epicyclic arrangement further comprises:
liners coupled to the carrier to prevent contact between the carrier and the planets.

6. The system of claim 5, where each liner completely surrounds a planet.

7. The system of claim 5, where each liner does not completely surround a planet.

8. The system of claim 1, further comprising:
a continuously variable transmission coupled to the epicyclic arrangement.

9. The system of claim 8, where the continuously variable transmission comprises a variator.

10. The system of claim 1, where the first input element comprises a sun that has a concave surface through which drive is transmitted from the sun to the planets.

11. The system of claim 10, where the second input element comprises an annulus that has a concave surface through which drive is transmitted from the annulus to the planets.

12.-20. (canceled)

21. A system comprising:
an epicyclic arrangement, comprising:
a first input element;
a second input element fixed to an input drive shaft;
a carrier that includes at least a portion that is disposed axially between the first and second input elements and being connected to an output member, the carrier having a center and openings aligned circumferentially about the center and angularly spaced apart;
a liner fixedly disposed in each opening in the carrier; and
a spherical planet disposed in each liner.

22. The system of claim 21, where the first input element is integral with an output disc of a variator.

23. The system of claim 21, where the spherical planets comprises five spherical planets.

24.-25. (canceled)

26. The system of claim 21, further comprising:
a continuously variable transmission coupled to the epicyclic arrangement.

27. (canceled)

28. A system comprising:
an epicyclic arrangement, comprising:
a sun;
an annulus fixed to an input drive shaft, the annulus including an annulus track having an annulus track diameter;
a carrier that includes at least a portion that is disposed axially between the sun and the annulus and being connected to an output member, the carrier having a center and openings aligned circumferentially about the center and angularly spaced apart; and
a spherical planet disposed in each opening, one of the spherical planets having a spherical planet diameter;
where the ratio of the spherical planet diameter to the annulus track diameter is 0.84 to 0.86.

29. The system of claim 28, where the sun is integral with an output disc of a variator.

30. The system of claim 28, where the spherical planets comprises five spherical planets.

31. The system of claim 28, where the epicyclic arrangement further comprises:
liners coupled to the carrier to prevent contact between the carrier and the planets.

32.-33. (canceled)

34. The system of claim 28, further comprising:
a continuously variable transmission coupled to the epicyclic arrangement.

35.-50. (canceled)
